(19) United States
(12) Patent Application Publication
(10) Pub. No.: US 2018/0296031 A1
(43) Pub. Date: Oct. 18, 2018

(54) Smoker or Grill Ash Management System

(71) Applicant: Masterbuilt Manufacturing, LLC, Columbus, GA (US)

(72) Inventors: Robert V. Terrell, JR., Auburn, AL (US); Daniel John Mercer, Hamilton, GA (US)

(21) Appl. No.: 15/950,592

(22) Filed: Apr. 11, 2018

Related U.S. Application Data
(60) Provisional application No. 62/484,463, filed on Apr. 12, 2017.

(51) Int. Cl. A47J 37/07

(52) U.S. Cl. CPC A47J 37/0786; A47J 37/0704

(57) ABSTRACT

A smoker or grill ash management system includes a fire pot, generally cylindrical in shape, with a top flame opening, a bottom discharge opening, and combustion air openings adjacent the top flame opening. A mesh floor is located in the fire pot near the bottom of the fire pot below the combustion air openings and proximate the discharge opening. The mesh floor is connected to an ash dump handle that is journaled into the fire pot for rotation. The ash dump handle rotates the mesh floor from a horizontal fuel pellet support position to a vertical dumping position. An ash cup is removably connected to the discharge opening of the fire pot below the mesh floor. The mesh floor allows the ash to drop out of the fire pot into the ash cup away from the air flow created by the combustion of the fuel pellets.

### CLAIM OF PRIORITY

This application claims priority from U.S. Provisional Patent Application Ser. No. 62/484,463, filed on Apr. 12, 2017, which is incorporated herein in its entirety.

### FIELD OF THE INVENTION

This invention relates to a smoker/grill for slowly cooking food while imparting a smoked flavor to the food, and more particularly to a smoker or grill ash management system for controlling the ash produced by burning fuel pellets to cook the food and impart the smoke flavor to the food.

### BACKGROUND OF THE INVENTION

In a conventional fuel pellet fired smoker or grill, fuel pellets, comprising wood material, are burned in order to cook the food and impart a smoked flavor to the food. As the fuel pellets burn, the fuel pellets produce ash that can be drawn into the area of the smoker where the food is being cooked and can be deposited on the food. Having ash settle onto the food being cooked is undesirable and should be avoided.

For example, a conventional smoker shown in the United States Patent Application Publication No. 20130174834 includes a combustion chamber with an opening at the bottom of the combustion chamber. The bottom opening is sealed by an access door so that ash from the burning fuel pellets accumulates on the access door at the bottom of the combustion chamber. The ash is periodically removed by opening the access door at the bottom of the combustion chamber to allow the ash to drop into a receptacle below the bottom opening of the combustion chamber. The draft created by the burning fuel pellets and forced air from a circulation fan tends to cause the lightweight ash that has accumulated in the bottom of the combustion chamber to rise into the area of the smoker where the food is located. Such circulation of ash into the cooking area represents a substantial problem for conventional fuel pellet fired smokers.

### SUMMARY OF THE INVENTION

The smoker or grill of the present invention overcomes the ash circulating problem of conventional smokers or grills such as the conventional smoker described above. Particularly, the smoker/grill of the present invention employs an ash management system to inhibit ash from circulating into the area of the smoker/grill containing the food. The smoker/grill of the present invention includes a cabinet or barrel supported on a base. The barrel has a lid for gaining access to the inside of the barrel. Lower cooking grates and upper grill racks are supported inside the barrel and are spaced apart for supporting food to be cooked. A grease deflector is positioned below the lower cooking grates to direct grease from the food to a grease tray for collection and disposal. A crucible or fire pot is supported inside the barrel below the lower cooking grates. A fire shield to disperse the heat evenly is positioned adjacent the fire pot. A pellet feeder feeds fuel pellets from a pellet hopper into the fire pot by means of an auger. An igniter adjacent to the fire pot ignites the fuel pellets in the fire pot. The burning fuel pellets cook the food and impart a smoked flavor to the food supported on the grill racks. A circulation fan, mounted at one end of the housing for the auger and remote from the fire pot, is used to control temperatures by forcing air through the auger housing and around the burning pellets.

In order to inhibit the circulation of ash created by the burning fuel pellets into the area of the smoker where the food is located, the ash management system of the present invention includes the fire pot, generally cylindrical in shape, with a flame opening at a top end, a discharge opening at a bottom end, and combustion air openings around the periphery of the fire pot adjacent the top end of the fire pot. A mesh floor is located in the fire pot near the bottom of the fire pot below the combustion air openings and above the discharge opening. The mesh floor is connected to an ash dump handle that is journaled into the sides of the fire pot. The opening into the fire pot that accommodates the dump handle is sealed with a heat resistant grommet in order to preclude leakage of air or smoke from the fire pot and/or the surrounding auger housing. The ash dump handle can be manipulated to rotate the mesh floor from a horizontal fuel pellet supporting position to a vertical dumping position that dumps the unburned pellets into the ash cup. The ash cup is removably connected to the discharge opening at the bottom of the fire pot below the mesh floor such as by means of a bayonet connection, threaded connection, or other suitable connection so that the ash cup can be removed for the disposal of the ash and unburned fuel pellets. The connection between the ash cup and the discharge opening of the fire pot is sealed by means of a heat resistant gasket in order to preclude leakage of air or smoke from the fire pot and/or the surrounding auger housing.

During the cooking and smoking operation, fuel pellets are fed into the fire pot by the auger, and the fuel pellets are supported on the mesh floor of the fire pot. The circulation fan forces combustion air into the fire pot through combustion air openings above the mesh floor. As the fuel pellets burn and turn to ash, the ash falls through the mesh floor into the ash cup below. The ash accumulates in the ash cup well below the combustion air openings and therefore well beyond the air flow between the combustion air openings and the top flame opening of the fire pot. Consequently, the ash is not circulated by means of the combustion air flow into the area of the smoker containing the cooking grates and grill racks, and therefore the ash is not deposited on the food being smoked.

Once the smoking process has concluded, the user manipulates the ash dump handle to rotate the mesh floor from the horizontal fuel pellet supporting position to the vertical dumping position thereby dumping the remainder of the unburned fuel pellets into the ash cup. The ash cup is then removed from below the barrel of the smoker so that the accumulated ash and unburned fuel pellets may be discarded. Alternatively, the mesh floor could comprise a tray that is constructed to slide into and out of a horizontal slot adjacent the discharge opening in the fire pot.

Further objects, features and advantages will become apparent upon consideration of the following detailed description of the invention when taken in conjunction with the drawings and the appended claims.

### BRIEF DESCRIPTION OF THE DRAWINGS

FIG. 1 is a front perspective view of a smoker in accordance with the present invention.

FIG. 2 is a front elevation of the smoker in accordance with the present invention.

FIG. 3 is a front elevation view of the smoker in accordance with the present invention with the front shelf and side shelf removed.

FIG. 4 is a front elevation view of the smoker in accordance with the present invention with the barrel and the barrel base removed to reveal internal detail.

FIG. 5 is a front elevation view of the smoker in accordance with the present invention with the barrel, the barrel base, the fire shield, the auger housing, and pellet hopper removed to reveal internal detail.

FIG. 6 is a front elevation view of the smoker in accordance with the present invention with the barrel, the barrel base, the fire shield, the auger housing, the auger cover, and the pellet hopper removed to reveal internal detail.

FIG. 7 is a back perspective section view of the smoker, similar to FIG. 6 reversed, in accordance with the present invention.

FIG. 8 is a bottom perspective view of the smoker in accordance with the present invention.

FIG. 9 is a top perspective view of the smoker in accordance with the present invention with the barrel, the barrel base, the food support racks, the grease deflector, and fire shield removed to reveal internal detail.

FIG. 10 is a bottom perspective view of the smoker in accordance with the present invention with the barrel, the barrel base, the food support racks, the grease deflector, and fire shield removed to reveal internal detail.

FIG. 11 is a bottom perspective view of the smoker in accordance with the present invention with the barrel, the barrel base, the food support racks, the grease deflector, the fire shield, and the auger housing removed to reveal internal detail.

FIG. 12 is a front perspective view of the smoker in accordance with the present invention with the barrel, the barrel base, the food support racks, the grease deflector, the fire shield, and the auger housing removed to reveal internal detail.

FIG. 13 is a top plan view of the smoker in accordance with the present invention with the barrel, the barrel base, the food support racks, the grease deflector, the fire shield, and the auger housing removed to reveal internal detail.

FIGS. 14A, 14B, and 14C R section views illustrating the fire pot, the ash cup, and the mesh floor all in accordance with the present invention.

FIG. 15 is a front perspective view of the smoker in accordance with the present invention with the barrel, the barrel base, the fire shield, the auger housing, and the fire pot removed to reveal internal detail.

FIG. 16 is a bottom plan view of the smoker in accordance with the present invention with the bottom shelf and the ash cup removed to reveal internal detail.

### DETAILED DESCRIPTION OF THE PREFERRED EMBODIMENT

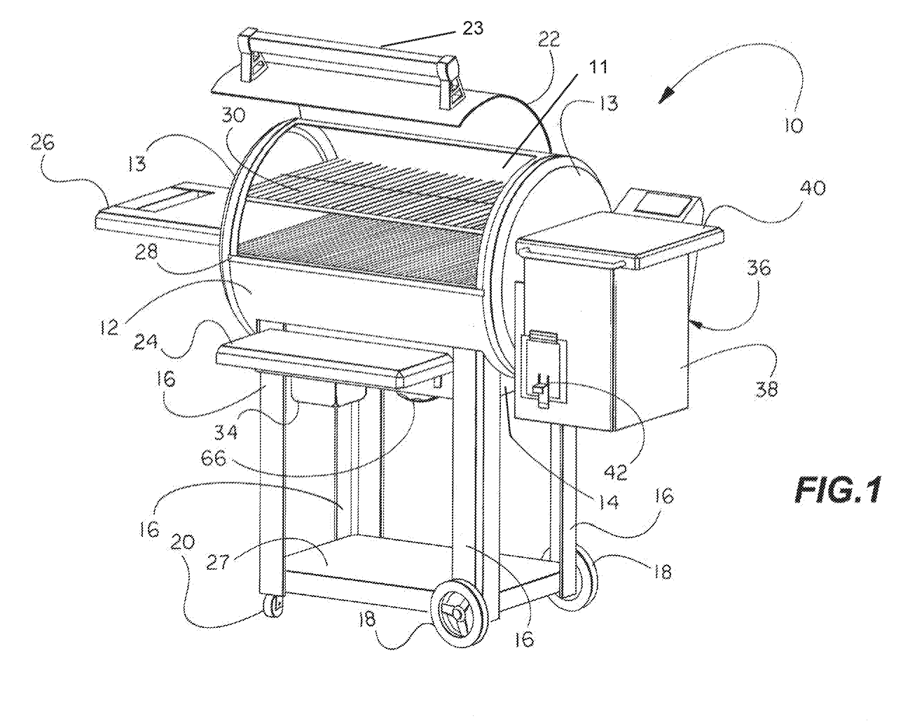

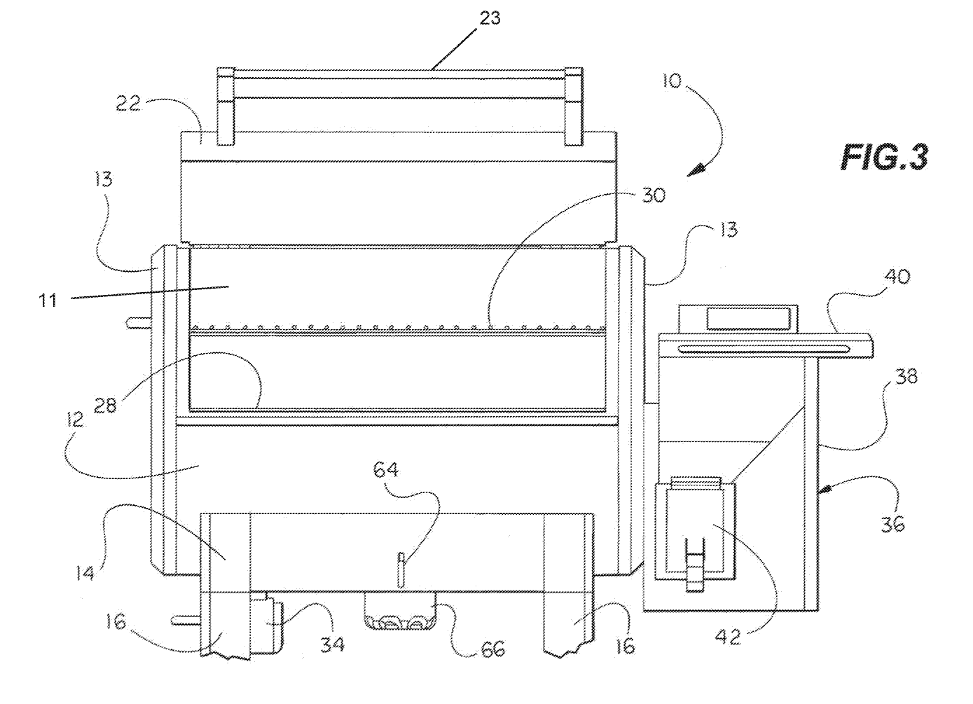

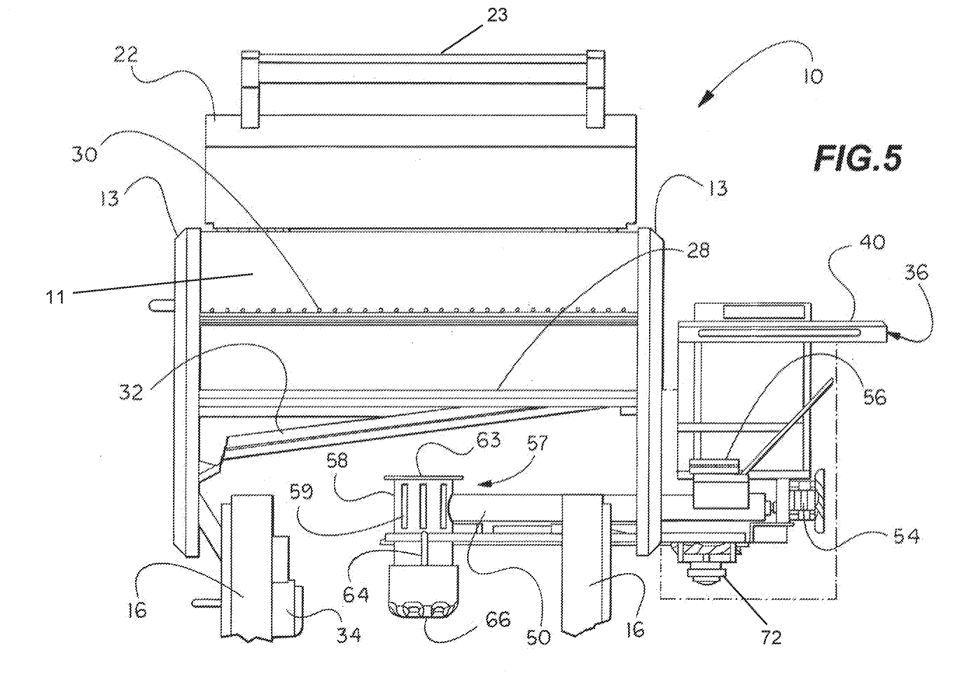

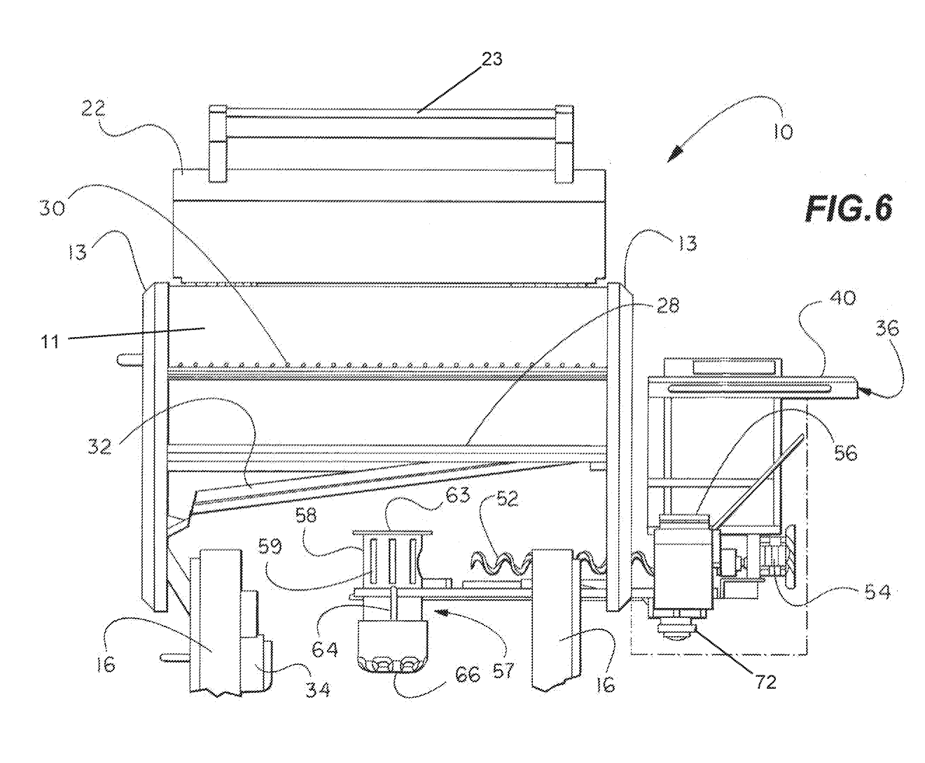

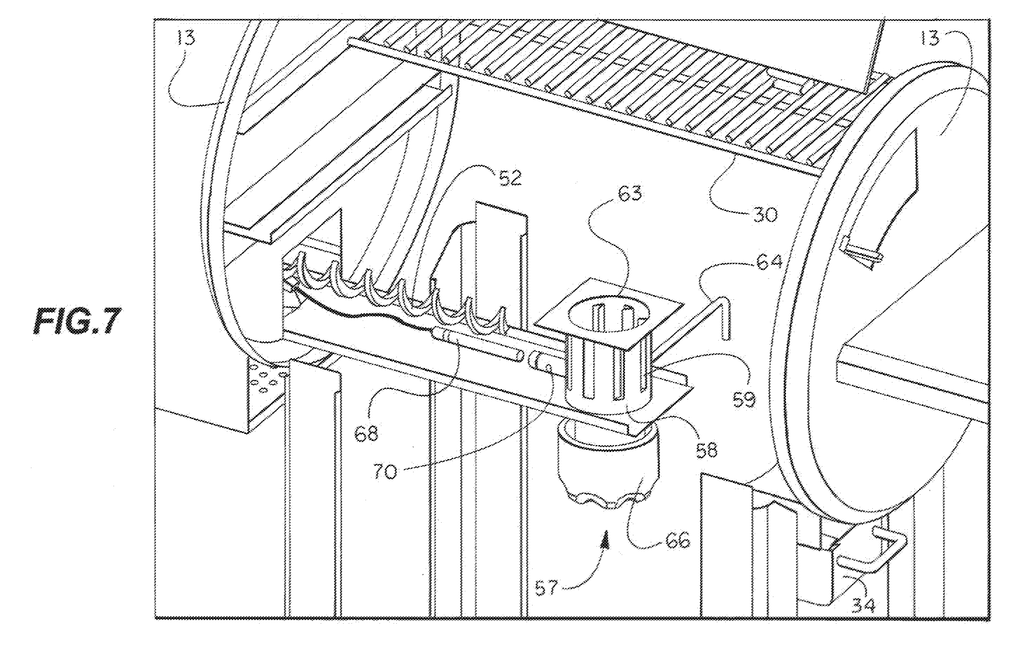

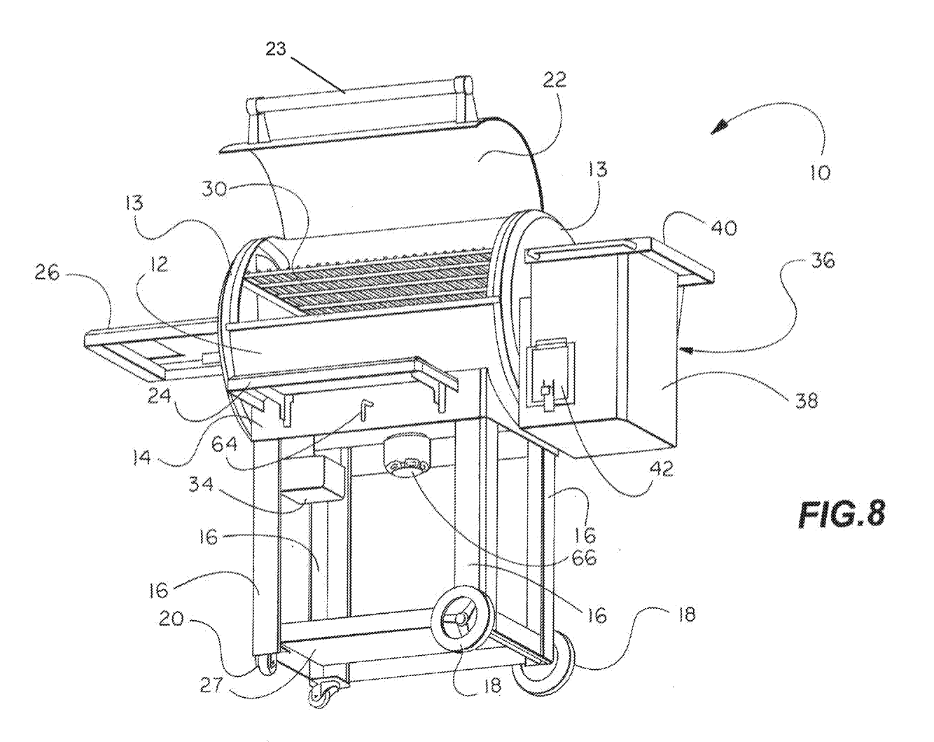

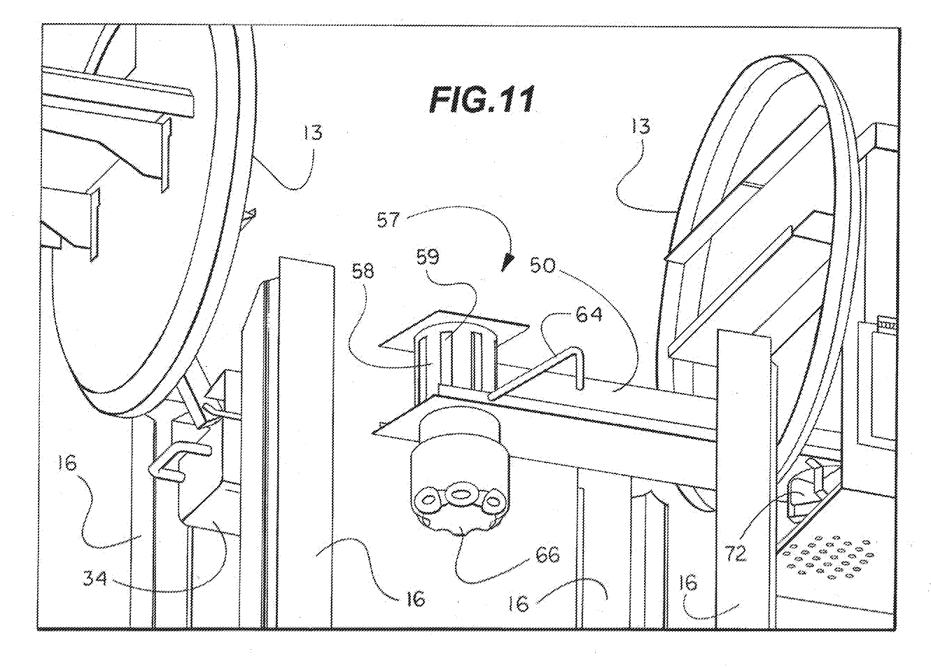

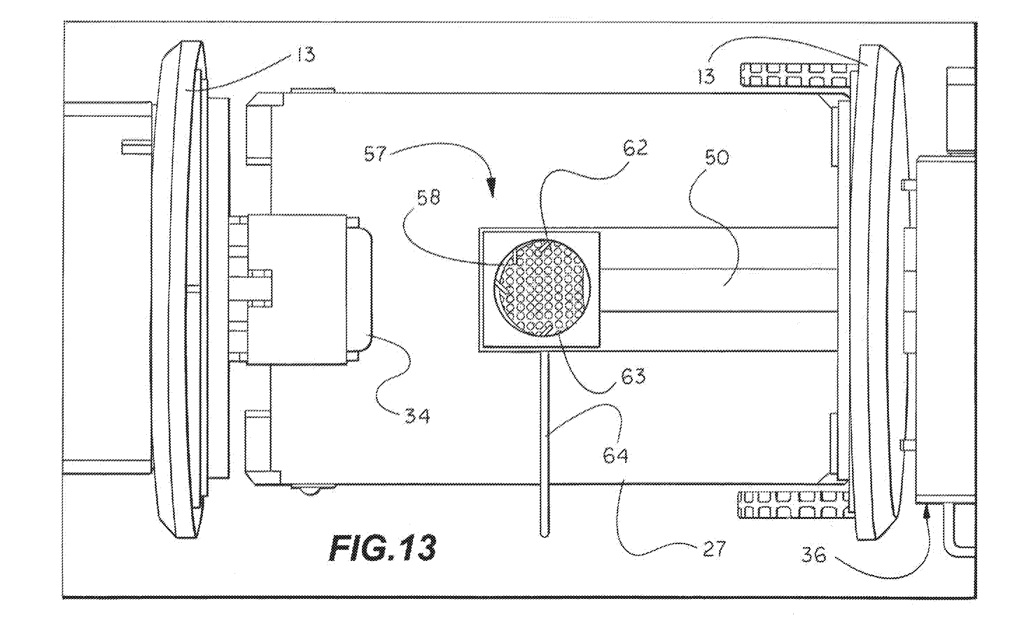

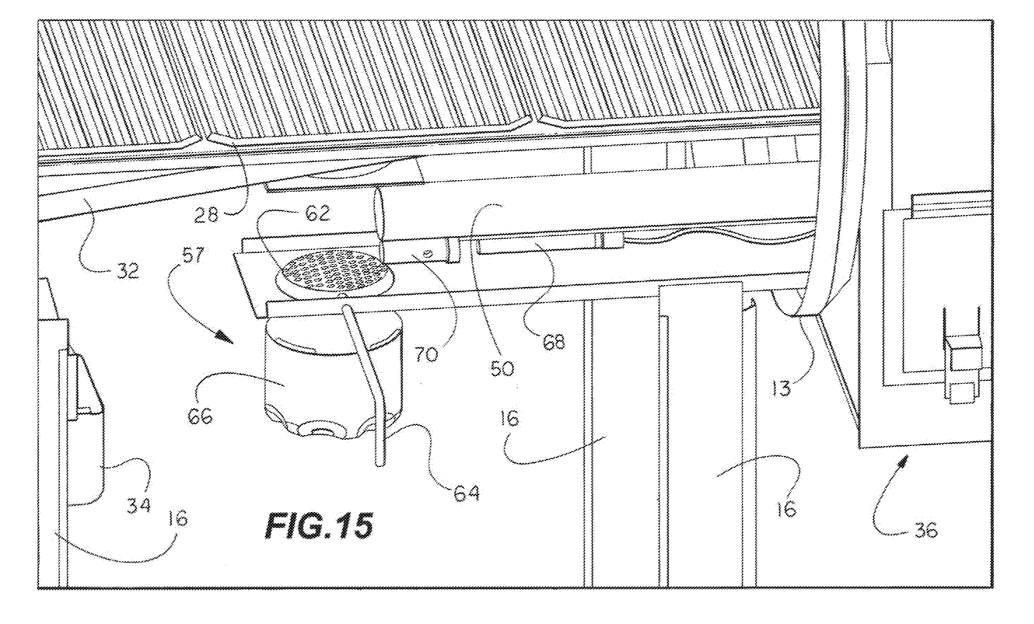

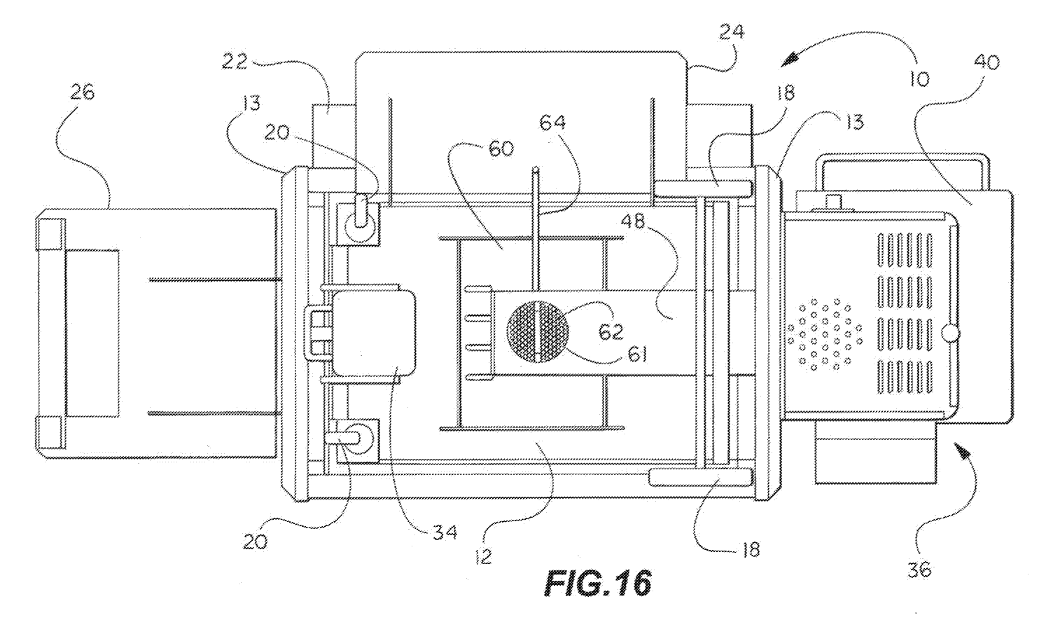

With reference to FIGS. 1-16, a fuel pellet fired smoker or grill 10, constructed in accordance with of the present invention, has an ash management system 57 (FIG. 5) that overcomes the ash circulating problem of conventional smokers or grills such as the conventional smoker described above. Particularly, the ash management system 57 inhibits ash from circulating into an area 11 of the smoker 10 containing the food.

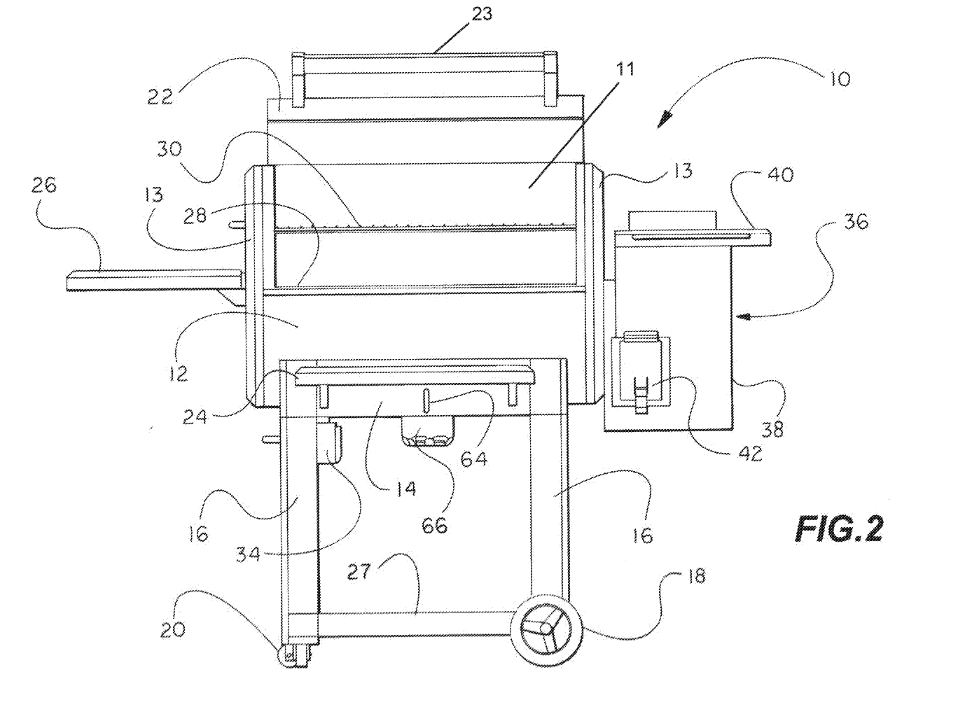

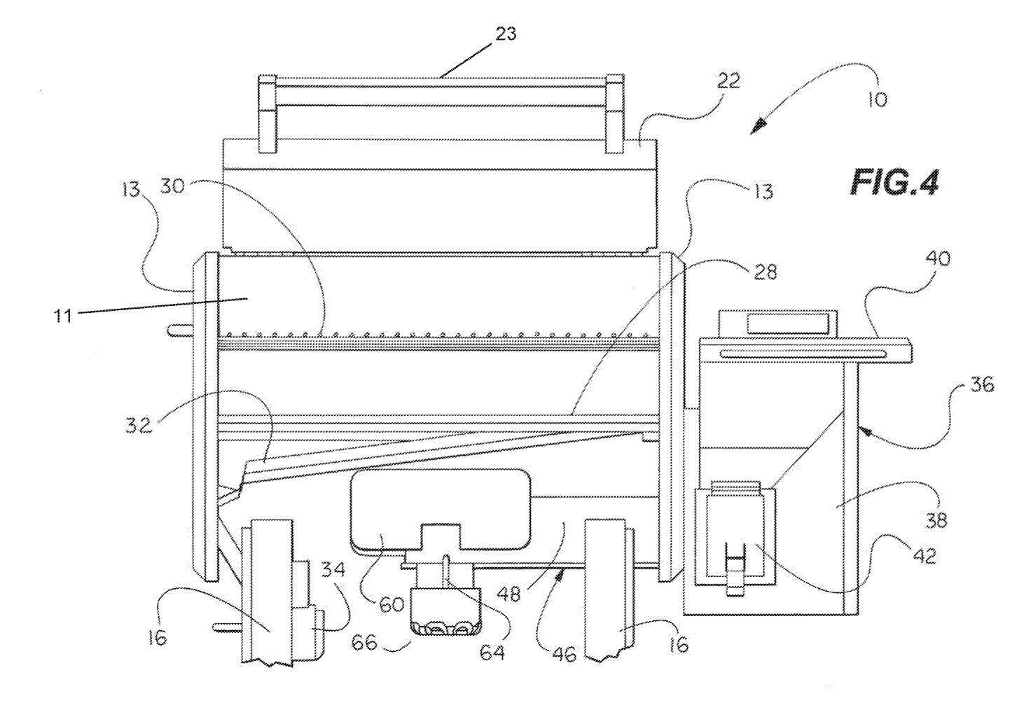

With reference to FIGS. 1 and 2, the smoker of the present invention includes a cabinet or barrel 12 having barrel ends 13 supported on a barrel base 14. The barrel 12 has a hinged lid 22 with a handle 23 for gaining access to the inside of the barrel 12. Lower cooking grates 28 and upper grill racks 30 are supported inside the barrel 12 by the barrel ends 13 and are spaced apart for supporting food to be cooked. A grease deflector 32 (FIG. 4) is supported by the barrel ends 13 and is positioned below the lower cooking grates 28 to direct grease from the food to a grease container 34 supported by one of the barrel ends 13 for collection and disposal.

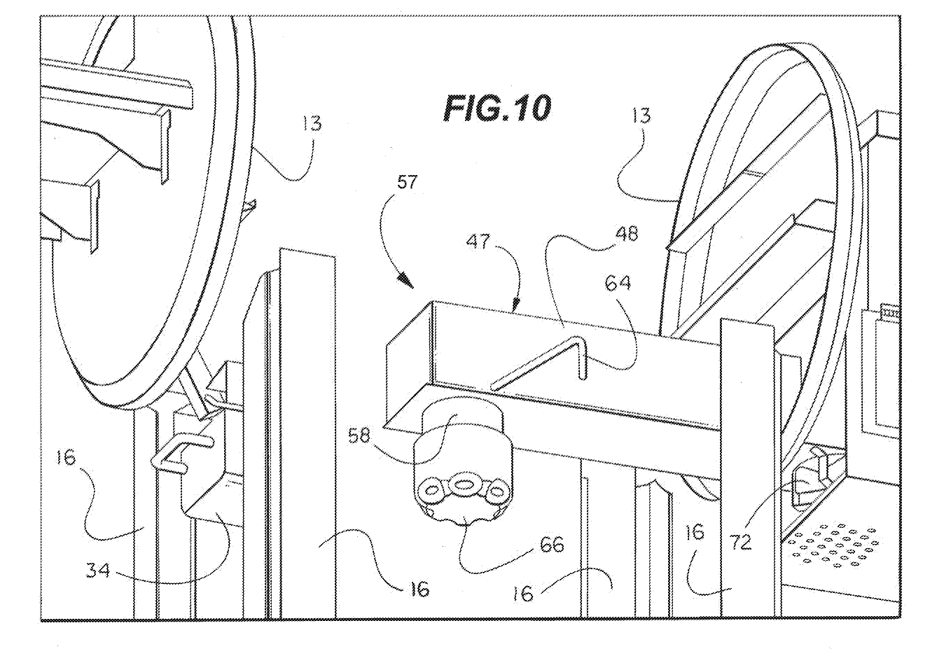

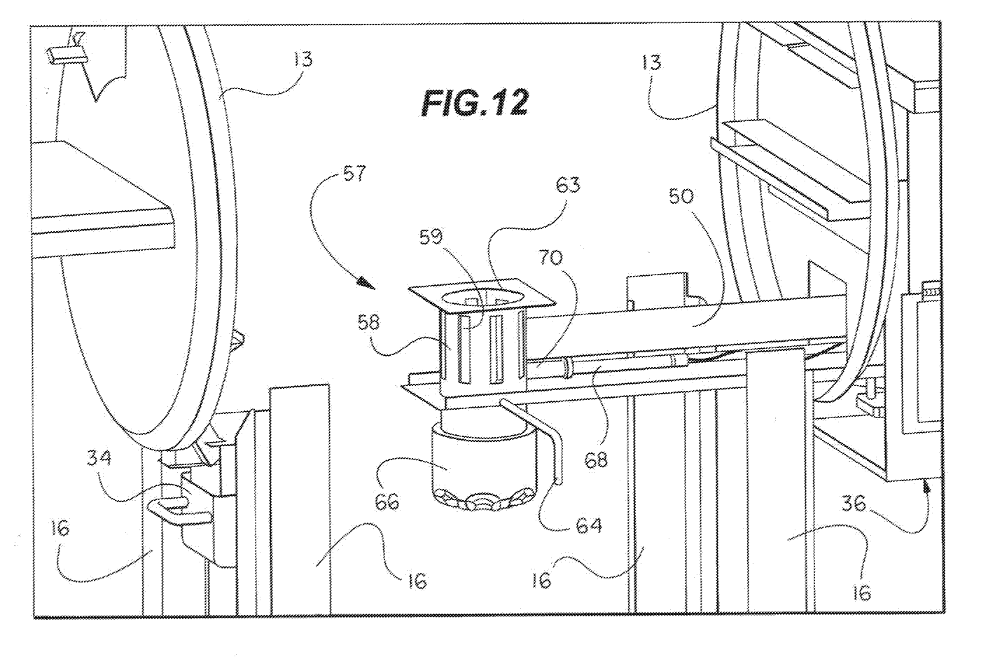

A crucible or fire pot 58 (FIG. 5) is centrally located inside the barrel 12 between the barrel ends 13 and below the lower cooking grates 28. A fire shield 60 (FIG. 4) is positioned adjacent the fire pot 58 to deflect the heat from the fire pot along the length of the barrel 12. A pellet feeder 36 (FIGS. 4 and 5) feeds pellets into the fire pot 58. The pellet feeder 36 comprises a pellet hopper 38 with a lid 40 and an auger 46. The auger 46 comprises an auger housing 48, an auger cover 50, an auger screw 52, an auger motor 54, and an auger inlet opening 56 at the bottom of the pellet hopper 38. The fuel pellets in the pellet hopper 38 are gravity fed into the auger 46 through the auger inlet opening 56 at the bottom of the pellet hopper 38. The auger screw 52 then transports the pellets from the pellet hopper 38 into the fire pot 58. An igniter 68 (FIG. 12) with an igniter holder 70 is positioned adjacent the fire pot 58 to ignite the fuel pellets in the fire pot 58. A circulation fan 72 (FIGS. 5, 6, 10, and 11) is positioned at one end of the auger housing 48 (FIG. 10) in order to force combustion air through the auger housing 48 and into the combustion air openings 59 of the fire pot 58.

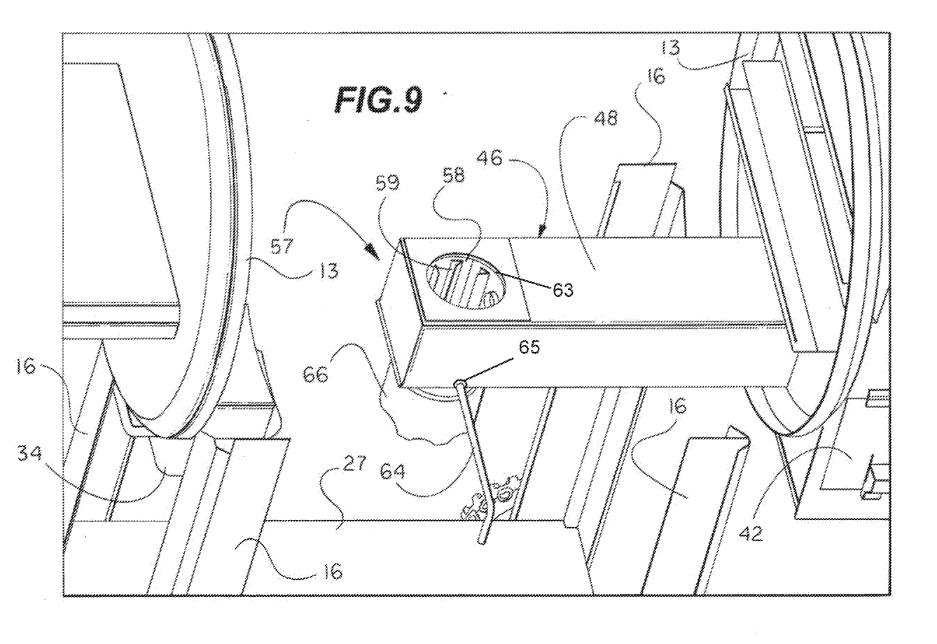

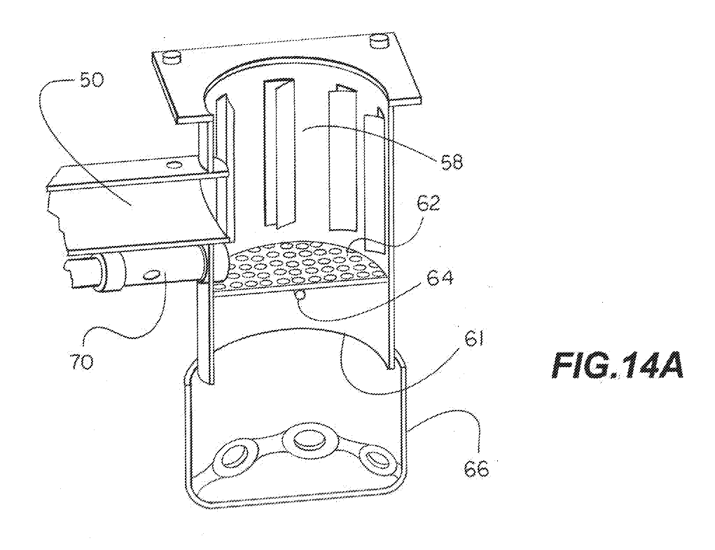

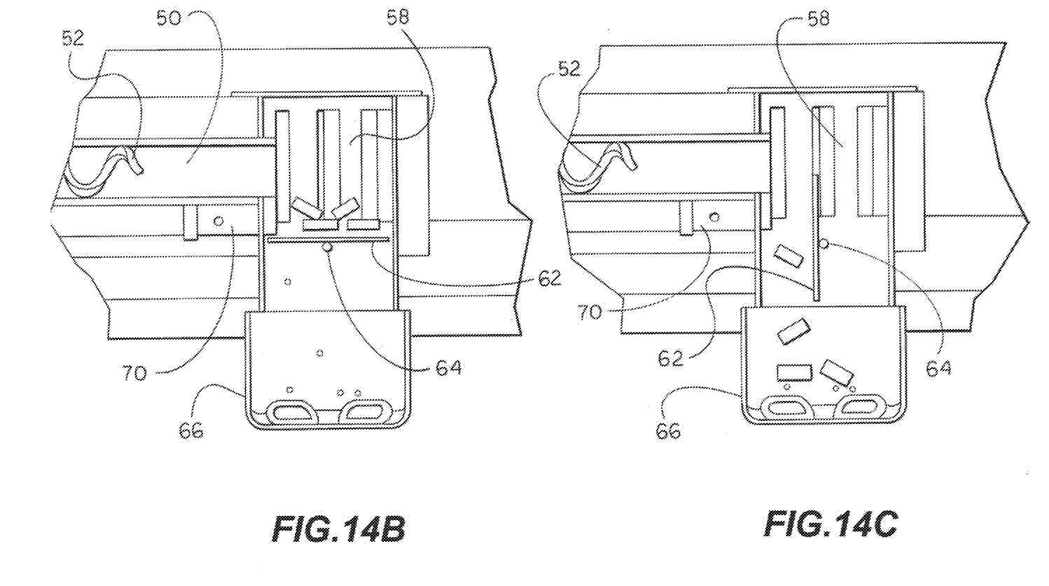

In order to inhibit the circulation of ash created by the burning fuel pellets into the area 11 of the smoker 10 where the food is located on the cooking grate 28 or the grill racks 30, the ash management system 57 of the present invention includes the fire pot 58 and an attached ash cup 66. The fire pot 58 is generally cylindrical in shape, with a flame opening 63 at a top end, a discharge opening 61 at a bottom end, and combustion air openings 59 around the periphery of the fire pot 58 adjacent the top end of the fire pot 58. A mesh floor 62 is located in the fire pot 58 near the bottom of the fire pot below the combustion air openings 59 and proximate the fire pot discharge opening 61. The mesh floor 62 conforms to the cylindrical shape of the fire pot 58 and covers the discharge opening 61. The mesh floor 62 is connected to an ash dump handle 64 that is journaled into the sides of the fire pot 58. The opening into the fire pot 58 that accommodates the dump handle 64 is sealed with a heat resistant grommet 65 (FIG. 9) in order to preclude leakage of air or smoke from the fire pot 63 and/or the surrounding auger housing 48. The ash dump handle 64 can be manipulated to rotate the mesh floor 62 from a horizontal fuel pellet supporting position (FIG. 14B) to a vertical dumping position (FIG. 14C). The mesh floor 62 has openings between 0.25 inch and 0.38 inch spaced at 0.30 inch center to center. The openings are sized and spaced so that the openings are large enough to assure that most of the ash will drop through the openings and are small enough to assure that the unburned pellets do not drop through the openings.

The ash cup 66 is cylindrically shaped with an open top and a closed bottom. The open top of the ash cup 66 is removably connected to the discharge opening 61 at the bottom of the fire pot 58 below the mesh floor 62 such as by means of a threaded connection, a bayonet connection, or other suitable releasable connection. The connection between the ash cup 66 and the discharge opening 61 of the fire pot 58 is sealed by means of a heat resistant gasket (not shown) in order to preclude leakage of air or smoke from the fire pot and/or surrounding auger housing 48.

During the cooking and smoking operation, fuel pellets are fed into the fire pot 58 by the auger 46, and the fuel pellets are supported on the mesh floor 62 (FIG. 14B). The fan 72 forces combustion air through the auger housing 48 and into the fire pot 58 through combustion openings 59 above the mesh floor 62. As the fuel pellets burn and turn to ash, the ash falls through the mesh floor 62 into the ash cup 66 below. Consequently, the ash accumulates in the ash cup 66 well below the combustion air openings 59 and therefore well beyond the combustion air flow between the combustion air openings 59 and the top flame opening 63 of the fire pot 58. Consequently, the ash is not circulated by means of the combustion air flow into the area 11 of the smoker 10 containing the cooking grates 28 and grill racks 30, and therefore the ash is not deposited on the food being smoked.

Once the smoking process has been concluded, the user manipulates the ash dump handle 64 to rotate the mesh floor 62 from the horizontal fuel pellet supporting position (FIG. 14B) to the vertical dumping position (FIG. 14C) thereby dumping the remainder of the unburned fuel pellets into the ash cup 66. The ash cup 66 is then removed from below the barrel 12 of the smoker 10 so that the accumulated ash and unburned fuel pellets may be discarded. Alternatively, the mesh floor 62 could comprise a tray that is constructed to slide into and out of a horizontal slot adjacent the discharge opening 61 in the fire pot 58.

While this invention has been described with reference to preferred embodiments thereof, it is to be understood that variations and modifications can be affected within the spirit and scope of the invention as described herein and as described in the appended claims.

I claim:

1. A fuel pellet fired smoker or grill for cooking a food product comprising:
a. an enclosed cabinet with an access door, and at least one rack vertically located within the cabinet for holding the food product to be cooked;
b. a combustion system for burning fuel pellets in a fire pot; and
c. an ash management system inside the cabinet for inhibiting ash created by the burning fuel pellets from circulating to the rack and therefore to the food product, the ash management system comprising:
i. the fire pot including:
(a) a upper flame opening;
(b) a lower discharge opening;
(c) combustion air openings adjacent the upper flame opening;
(d) a mesh floor with openings positioned in the fire pot proximate the lower discharge opening; and
ii. an ash cup connected to the lower discharge opening for receiving ash through the mesh floor.

2. The smoker or grill of claim 1, wherein the mesh floor is rotatably mounted in the fire pot for rotation between a support position for the fuel pellets and a dumping position for the fuel pellets.

3. The smoker or grill of claim 1, wherein the mesh floor is slidably mounted in the fire pot for sliding between a support position for the fuel pellets and a dumping position for the fuel pellets.

4. The smoker or grill of claim 1, wherein the openings of the mesh floor are sized and spaced so that the openings are large enough to assure that the ash will drop through the openings and are small enough to assure that the unburned pellets do not drop through the openings.

5. The smoker or grill of claim 4 wherein the openings of the mesh floor are between 0.25 inch and 0.38 inch spaced at approximately 0.30 inch center to center.

6. The smoker or grill of claim 1, wherein the ash cup is removably connected to the lower discharge opening.
